(19) United States
(12) Patent Application Publication
(10) Pub. No.: US 2024/0303140 A1
(43) Pub. Date: Sep. 12, 2024

(54) COMMUNICATION METHOD FOR FLUTTER WEB APPLICATION AND HOST PROGRAM, AND COMPUTER DEVICE

(71) Applicant: BOE Technology Group Co., Ltd., Beijing (CN)

(72) Inventor: Cunqing LI, Beijing (CN)

(21) Appl. No.: 18/275,924

(22) PCT Filed: Nov. 23, 2021
(86) PCT No.: PCT/CN2021/132484

§ 371 Date: Aug. 4, 2023

(51) Int. Cl. G06F 9/54

(52) U.S. Cl. CPC G06F 9/547; G06F 9/546

(57) ABSTRACT

The present disclosure relates to a communication method for a Flutter Web application and a host program, and a computer device. The method includes: acquiring a communication mode between the Flutter Web application and the host program, where the communication mode includes a WebSocket communication mode and/or a JavaScript communication mode; communicating, according to the communication mode, with the host program through a first communication component, where the first communication component is arranged in the Flutter Web application and realizes information interaction based on a preset information format. The present embodiment can make use of characteristics that a Flutter framework can set a channel, and the Flutter Web application can establish a communication channel with a host program by setting a first communication component. Communication through the communication channel can improve efficiency of message monitoring and transmission, thereby enhancing an application range of the Flutter framework.

### TECHNICAL FIELD

The present disclosure relates to the field of communication technology, and in particular, to a communication method for a Flutter Web application and a host program, and a computer device.

### BACKGROUND

Flutter is a cross-platform UI development framework. Flutter can run on platforms such as Android system, iOS system, Windows and Web. Flutter has characteristics of rapid development and characteristics of cross-platform and cross-multi-terminal. In practical application, a Flutter program can be compiled into a Flutter Web program, and then the Flutter Web program is built into host programs of various platforms (such as Windows/Linux/Mac/Android system/iOS system/Web). The Flutter Web program mixes functions of a native Web, and can use a Web program to interactively communicate with a host program. However, some features (such as channel) of a Flutter framework cannot be directly applied to the Flutter Web program.

### SUMMARY

The present disclosure provides a communication method for a Flutter Web application and a host program, a computer device, to solve defects in related arts.

According to a first aspect of embodiments of the present disclosure, a communication method for a Flutter Web application and a host program is provided, where the host program includes at least one of: an Android system, an iOS system, a Windows system or a Web program; and the host program is used to provide a runnable environment for the Flutter Web application: the method includes:
acquiring a communication mode between the Flutter Web application and the host program, where the communication mode includes at least one of a WebSocket communication mode or a JavaScript communication mode; and
communicating, according to the communication mode, with the host program through a first communication component, where the first communication component is arranged in the Flutter Web application and realizes information interaction based on a preset information format.

Optionally, the preset information format includes at least one of: parameter initialization (init), message sending (sendMessage), asynchronous message sending (sendMessageAsync) and message monitoring (onReceiveMessage).

Optionally, communicating, according to the communication mode, with the host program through the first communication component includes:
when the communication mode is WebSocket communication mode, selecting, by the Flutter Web application, the first communication component, and communicating, by the Flutter Web application, with the host program through the first communication component.

Optionally, communicating, by the Flutter Web application, with the host program through the first communication component includes:
sending, by the Flutter Web application, a first message to the first communication component, such that the first communication component converts the first message to a second message and sends the second message to the host program; and the host program generates, according to the second message, a first response message and sends the first response message to the first communication component: where the first message and the second response message adopt a Flutter data format, and the second message and the first response message adopt a JavaScript data format; and
acquiring, by the Flutter Web application, a second response message returned by the first communication component.

Optionally, communicating, by the Flutter Web application, with the host program through the first communication component includes:
acquiring, by the Flutter Web application, a fourth message sent by the first communication component, where the fourth message is obtained by converting, by the first communication component, a third message from the host program; and
in response to the fourth message, generating, by the Flutter Web application, a third response message and sending the third response message to the first communication component, to cause the first communication component to convert the third response message to a fourth response message and send the fourth response message to the host program;
where the fourth message and the third response message adopt a Flutter data format, and the third message and the fourth response message adopt a JavaScript data format.

Optionally, the first communication component includes an interface provided by a Flutter end in the Flutter Web application to be called by a JavaScript end in the host program, so as to convert a Flutter data format of the Flutter end and a JavaScript data format of the JavaScript end.

Optionally, communicating, according to the communication mode, with the host program through the first communication component includes:
when the communication mode is the JavaScript communication mode, selecting, by the Flutter Web application, the first communication component and a second communication component, and communicating, by the Flutter Web application, with the host program through the first communication component and the second communication component;
where the first communication component is arranged in the Flutter Web application and realizes information interaction based on a preset information format: the second communication component is arranged in the host program and realizes information interaction based on the preset information format.

Optionally, communicating, by the Flutter Web application, with the host program through the first communication component and the second communication component includes:
sending, by the Flutter Web application, a first message to the first communication component, such that the first communication component converts the first message to a second message and sends the second message to the second communication component: the second communication component converts the second message to a third message and sends the third message to the host program: the host program generates, according to the third message, a first response message and sends the first response message to the second communication component: the second communication component converts the first response message to a second response message and sends the second response message to the first communication component; and the first communication component converts the second response message to a third response message: where the first message and the third response message adopt a Flutter data format, the second message and the second response message adopt a JavaScript data format, and the third message and the first response message adopt a data format of the host program; and
acquiring, by the Flutter Web application, a third response message returned by the first communication component.

Optionally, communicating, by the Flutter Web application, with the host program through the first communication component and the second communication component includes:
acquiring, by the Flutter Web application, a fourth message sent by the first communication component, where the fourth message is obtained by converting, by the first communication component, a fifth message from the second communication component; and the fifth message is obtained by converting, by the second communication component, a sixth message from the host program; and
in response to the fourth message, generating, by the Flutter Web application, a fourth response message and sending the fourth response message to the first communication component, to cause the first communication component to convert the fourth response message to a fifth response message and send the fifth response message to the second communication component; and to cause the second communication component to convert the fifth response message to a sixth response message and send the sixth response message to the host program;
where the fourth message and the fourth response message adopt a Flutter data format, the fifth message and the fifth response message adopt a JavaScript data format, the sixth message and the sixth response message adopt a data format of the host program.

Optionally, the second communication component includes an interface obtained by encapsulating a Dart script library, so as to convert a JavaScript data format of a JavaScript end and a data format corresponding to the host program.

According to a second aspect of embodiments of the present disclosure, a communication method is provided, applied to a Flutter Web application, the method includes:
acquiring a communication mode between the Flutter Web application and a host program, where the communication mode includes at least one of a WebSocket communication mode or a JavaScript communication mode; and
communicating, according to the communication mode, with the host program through a first communication component, where the first communication component is arranged in the Flutter Web application and realizes information interaction based on a preset information format.

Optionally, the preset information format includes at least one of: parameter initialization (init), message sending (sendMessage), asynchronous message sending (sendMessageAsync) and message monitoring (onReceiveMessage).

Optionally, when the communication mode is the WebSocket communication mode, communicating, by the Flutter Web application, with the host program through the first communication component includes:
sending a first message to the first communication component, to cause the first communication component to convert the first message to a second message and send the second message to the host program; and
acquiring a first response message returned by the host program, converting the first response message to a second response message, and acquiring the second response message.

Optionally, when the communication mode is the WebSocket communication mode, the communicating, by the Flutter Web application, with the host program through the first communication component includes:
acquiring a fourth message sent by the first communication component, where the fourth message is obtained by converting, by the first communication component, a third message from the host program; and
in response to the fourth message, generating a third response message and sending the third response message to the first communication component, to cause the first communication component to convert the third response message to a fourth response message and send the fourth response message to the host program;
where the fourth message and the third response message adopt a Flutter data format, and the third message and the fourth response message adopt a JavaScript data format.

Optionally, when the communication mode is the JavaScript communication mode, communicating, according to the communication mode, with the host program through the first communication component includes:
sending a first message to the first communication component, to cause the first communication component to convert the first message to a second message and send the second message to a second communication component;
acquiring a second response message sent by the second communication component and converting the second response message to a third response message;
acquiring a third response message returned by the first communication component;
where the first message and the third response message adopt a Flutter data format, and the second message and the second response message adopt a JavaScript data format.

Optionally, when the communication mode is the JavaScript communication mode, communicating, according to the communication mode, with the host program through the first communication component includes:
acquiring a fourth message sent by the first communication component, where the fourth message is obtained by converting, by the first communication component, a fifth message from a second communication component;
in response to the fourth message, generating a fourth response message and sending the fourth response message to the first communication component, to cause the first communication component to convert the fourth response message to a fifth response message and send the fifth response message to the second communication component;
where the fourth message and the fourth response message adopt a Flutter data format, and the fifth message and the fifth response message adopt a JavaScript data format.

According to a third aspect of embodiments of the present disclosure, a computer device is provided, including:
a processor;
a memory for storing a computer program executable by the processor;
where the processor is configured to execute the computer program in the memory to implement the method according to any one of the first aspect.

According to a fourth aspect of embodiments of the present disclosure, a computer-readable storage medium is provided, where when an executable computer program in the storage medium is executed by a processor, the method according to any one of the first aspect is implemented.

A technical solution provided by embodiments of the present disclosure may include following beneficial effects:

As can be known from above embodiments, a solution provided by the embodiments of the present disclosure can load a Flutter Web application to a host program, where the host program includes at least one of the following: an Android system, an iOS system, a Windows system or a Web program; and the host program is used to provide a runnable environment for the Flutter Web application: the Flutter Web application can acquire a communication mode between the Flutter Web application and the host program, where the communication mode includes a WebSocket communication mode and/or a JavaScript communication mode; and the Flutter Web application can communicate, according to the communication mode, with the host program through a first communication component, where the first communication component is arranged in the Flutter Web application and realizes information interaction based on a preset information format. In such way, the present embodiment can make use of characteristics that a Flutter framework can set a channel, and the Flutter Web application can establish a communication channel with a host program by setting a first communication component. Communication through the communication channel can improve efficiency of message monitoring and transmission, thereby enhancing an application range of the Flutter framework.

It is to be understood that both foregoing general description and following detailed description are illustrative and explanatory only, and cannot limit the present disclosure.

### BRIEF DESCRIPTION OF DRAWINGS

The accompanying drawings, which are incorporated in and constitute a part of the present specification, illustrate embodiments consistent with the present disclosure, and together with the description, serve to illustrate principles of the present disclosure.

FIG. 1 is a schematic application architecture diagram of a Flutter Web application according to an illustrative embodiment.

FIG. 2 is a flowchart of a communication mode according to an illustrative embodiment.

FIG. 3 is a flowchart of another communication mode according to an illustrative embodiment.

FIG. 4 is a flowchart of a communication method for a Flutter Web application and a host program according to an illustrative embodiment.

### DETAILED DESCRIPTION

Description will now be made in detail to illustrative embodiments, examples of which are shown in the accompanying drawings. When the following description refers to the drawings, unless otherwise indicated, the same numbers in different drawings indicate the same or similar elements. Embodiments illustratively described in the following embodiments do not represent all embodiments consistent with the present disclosure. In contrary, they are merely examples of apparatuses consistent with some aspects of the present disclosure as described in detail in the appended claims. It should be noted that features in the following embodiments and implementations can be combined with each other as long as no conflict is resulted.

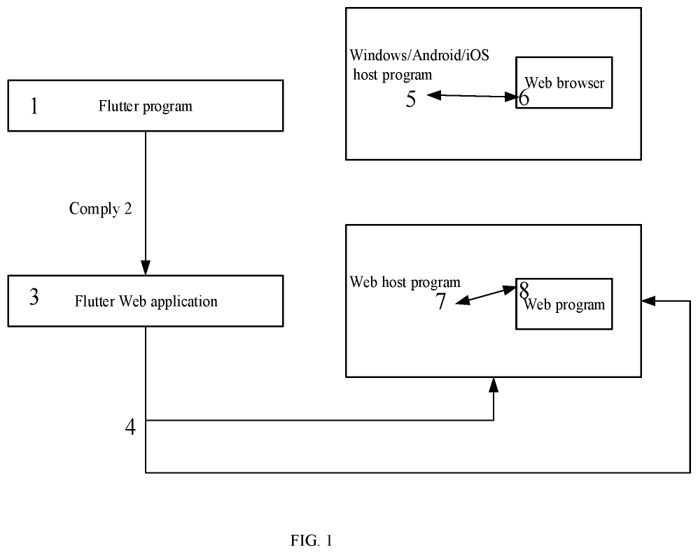

To solve the above technical problems, embodiments of the present disclosure provide a communication method for a Flutter Web application and a host program. FIG. 1 is a schematic communication architecture diagram of the Flutter Web application and the host program according to an illustrative embodiment. As shown in FIG. 1, the Flutter Web application 3 can be obtained by performing a complying step 2 on a Flutter application 1. Then the Flutter Web application 3 is loaded on a host program 5 and a host program 7 to form a parasitic program 6 and a parasitic program 8.

In an embodiment, the host program 5 can be realized by adopting a native program, where the native program is also referred to as a Native program, such as a Windows system, an Android system and an iOS system, etc. When serving as the host program, the Native program can provide a runnable environment for the Flutter Web application, where the runnable environment may also be referred to as a container. In practical application, the container may be a piece of code or a framework, etc. When the host program 5 is the native program, the container thereof can be realized by adopting a browser kernel (WebBrowser as shown in FIG. 1, i.e. WEB program).

In an embodiment, the host program 7 may be realized by adopting a non-native program, such as a Web program (e.g., Web as shown in FIG. 1), etc. When serving as the host program, the Web program can provide a runnable environment (i.e., a container) for the Flutter Web application 3.

Still referring to FIG. 1, in the present embodiment, after the Flutter Web application 3 is loaded on the host program 5 and the host program 7, when the Flutter Web application 3 communicates with the host program 5 and the host program 7 respectively, the Flutter Web application 3 may perceive that the host program 5 and the host program 7 belong to different platforms due to different communication mechanisms, or may perceive parasitized to different hosts. To avoid above circumstances, the present embodiment improves the Flutter Web application and the host program, so as to make the Flutter Web application adapt to application scenarios of both the Native program and the Web program, thereby achieving insensitivity on different platforms or hosts.

In the present embodiment, the Flutter Web application is provided with a first communication component, where the first communication component is arranged in the Flutter Web application, and realizes information interaction based on a preset information format. The preset information format includes at least one of the following: parameter initialization (init), message sending (sendMessage), asynchronous message sending (sendMessageAsync) and message monitoring (onReceiveMessage). A structure is as follows:
IMessenger
+init( )
+sendMessage( ) string
+sendMessageAsync( ) string
+onReceiveMessage( )

Data reception and transmission between the Flutter Web application and the host program may be based on the preset information format, which is beneficial to efficiency improvement. In addition, the first communication component includes an interface provided by a Flutter end to be called by a JavaScript end in the host program, that is, the Flutter end needs to provide the interface (referred to as FlutterInterface, FI) to be called by the JavaScript end. A code is as follows:

```
  ///Register a function of the Flutter end that can be called by the JS end (by calling
winodow.flutterCallback)
  @js(‘flutterCallback’)
  External set_flutterCallback(void Function(dynamic val) f) ;
  ///Register a function name to Window of JS.
  @JS( )
  External void FunctionName(dynamic val);
  Void_flutterCallbackImpl(dynamic val) {
    Print(‘@flutter_flutterCallbackImpl( ) val:$val’);
  }
```

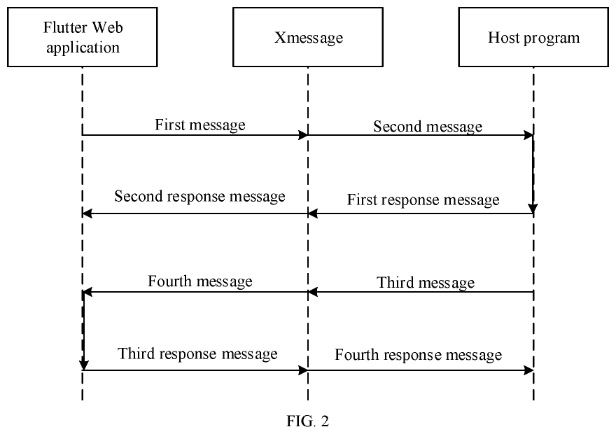

In such way, the Flutter Web application can communicate with the host program through the first communication component. The host program can be realized by adopting the Web program, the Windows system, the Android system program and the iOS system program, etc., as shown in FIG. 1. At this time, the Flutter Web application can establish a WebSocket channel to the host program through the first communication component, and can realize message monitoring and sending through the WebSocket channel. Alternatively, under the WebSocket communication mode, the Flutter Web application can communicate with the host program through the first communication component, and a flow thereof is shown in FIG. 2.

As shown in FIG. 2, when the Flutter Web application sends a message to the host program, the step includes: the Flutter Web application sends a first message to the first communication component (i.e., XMessage). The first communication component XMessage converts the first message to a second message, and sends the second message to the host program. The host program generates a first response message according to the second message, and sends the first response message to the first communication component. The first communication component converts the first response message to a second response message. The Flutter Web application acquires the second response message returned by the first communication component. The first message and the second response message adopt a Flutter data format, and the second message and the first response message adopt a JavaScript data format. In such way, the Flutter Web application completes a message request operation and a message reception operation with the host program through the first communication component.

Still referring to FIG. 2, when the host program sends a message to the Flutter Web application, the step includes:

The Flutter Web application acquires a fourth message sent by the first communication component, where the fourth message is obtained by converting, by the first communication component, a third message from the host program. The Flutter Web application can generate, in response to the fourth message, a third response message, and send the third response message to the first communication component. The first communication component converts the third response message to a fourth response message, and sends the fourth response message to the host program. In such way, the Flutter Web application can complete a message request operation and a message response operation with the host program.

In addition, the WebSocket itself has characteristics of a long link, thus the present embodiment can easily implement message sending and message monitoring, hence efficiency of message sending and message monitoring between the Flutter Web application and the host program can be improved.

In an embodiment, the host program is provided with a second communication component, where the second communication component is arranged in the host program, and realizes information interaction based on the preset information format, where the preset information format is same as the information format of the first communication component. The second communication component includes an interface obtained by encapsulating a Dart script library, so as to convert a JavaScript data format of a JavaScript end and a data format corresponding to the host program. That is, an interface for sending from the Flutter end to the JavaScript end (referred to as JavaScriptInterface, JSI).

In addition, this part is realized by encapsulating a JS library of Dart.

Encapsulation code for encapsulating the JS library of Dart is implemented as follows:

///calls invoke javaScript ‘JSON.stringify(obj)’
@js (‘JSON.stringify’)
External string stringify (object obj);
@JS (‘parent.jsBridge.hello’)
@JS (‘parent.jsBridge.hello’)
@JS (‘parent.jsBridge.helloAsync’)
External dynamic_helloAsync(dynamic command, dynamic arg);
@JS (‘parent.jsBridge.sendMessage’)
External dynamic_sendMessage(Message, msg);
///JSI: JavaScript Interface
///
/// An interface of the JS end exposed to the Flutter.
///
///Support
///-Synchronous call
///-Synchronous call
///
Class JSI{
///send Dart-type data to the JS end
Static void sendMessage(Message msg){
_sendMessage(msg);
}
}

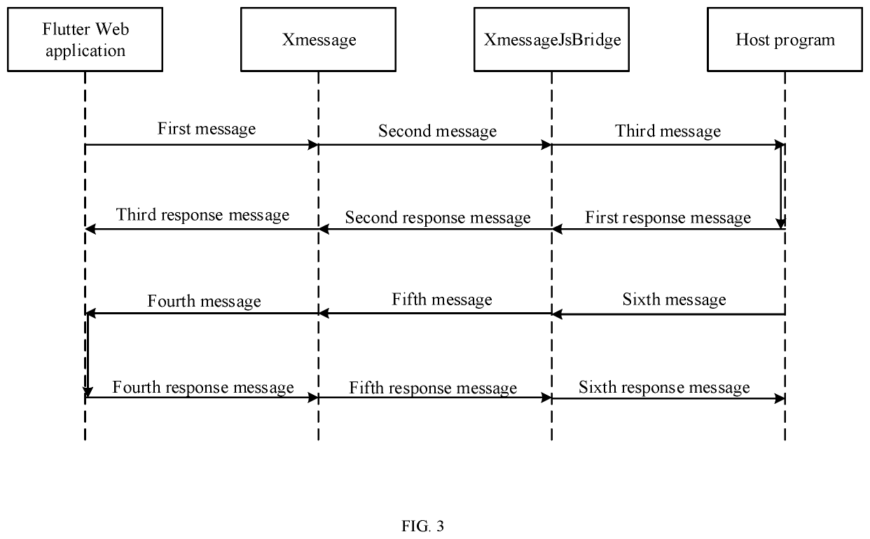

In such way, the Flutter Web application can communicate with the host program through the first communication component and the second communication component. The host program can be the Web program, the Windows system, the Android system program and the iOS system program, etc., as shown in FIG. 1. At this time, the Flutter Web application can establish a JavaScript communication channel with the host program, and message monitoring and message sending can be implemented through the JavaScript communication channel. Alternatively, under the JavaScript communication mode, the Flutter Web application can communicate with the host program through the first communication component and the second communication component, and a flow thereof is shown in FIG. 3.

As shown in FIG. 3, when the Flutter Web application sends a message to the host program, the step includes:

The Flutter Web application sends a first message to the first communication component in the Flutter Web application. The first communication component can convert the first message to a second message, and send the second message to the second communication component. The second communication component can convert the second message to a third message, and send the third message to the host program. The host program can generate, according to the third message, a first response message, and send the first response message to the second communication component. The second communication component can convert the first response message to a second response message and send the second response message to the first communication component. The first communication component can convert the second response message to a third response message and send the third response message to the Flutter Web application. The Flutter Web communication can acquire the third response message returned by the first communication component. The first message and the third response message can adopt a Flutter data format, the second message and the second response message can adopt a JavaScript data format, the third message and the first response message can adopt a data format of the host program. In such way, the Flutter Web application completes a message request operation and a message reception operation with the host program through the first communication component and the second communication component.

Still referring to FIG. 3, when the host program sends a message to the Flutter Web application, the step includes: the host program can send a sixth message to the second communication component. The second communication component converts the sixth message from the host program to a fifth message and sends the fifth message to the first communication component. The first communication component converts the fifth message to a fourth message and sends the fourth message to the Flutter Web application. The Flutter Web application can generate, in response to the fourth message, a fourth response message and send the fourth response message to the first communication component. The first communication component converts the fourth response message to a fifth response message and sends the fifth response message to the second communication component. The second communication component converts the fifth response message to a sixth response message and sends the sixth response message to the host program. In such way, the Flutter Web application completes a request message response operation with the host program through the first communication component and the second communication component.

The content of the above embodiments describe content of the WebSocket communication mode and the JavaScript communication mode. It can be understood that in the architecture shown in FIG. 1, preset configuration information can be stored in the Flutter Web application, where the preset configuration information includes the WebSocket communication mode and the JavaScript communication mode. Thus, the Flutter Web application can acquire the communication mode in the preset configuration information, and then establish a communication connection with the host program according to the communication mode, and communicate with the host program based on the communication connection. That is, the Flutter Web application can communicate with the host program through the first communication component, or the first communication component and the second communication component. Due to presence of the first communication component and the second communication component, the Flutter Web application can communicate with host programs with insensitivity, thereby improving communication effect. Alternatively, due to presence of the first communication component and the second communication component, developers or maintainers of Flutter only need to develop or maintain the program on the Flutter end, and do not need to work on host program adaption, which makes the developers or maintainers insensitive to types of the host program, thereby improving efficiency.

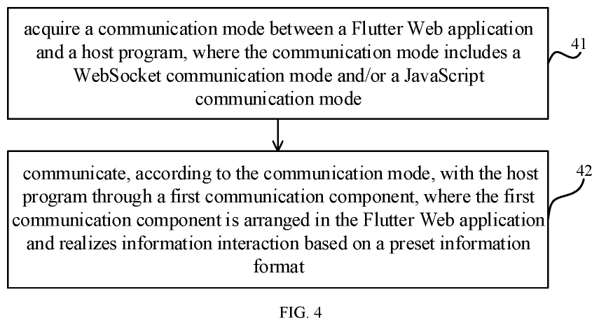

Based on the architecture shown in FIG. 1, an embodiment of the present disclosure provides a communication method for a Flutter Web application and a host program, as shown in FIG. 4, the method including:
step 41, acquiring a communication mode between the Flutter Web application and the host program, where the communication mode includes a WebSocket communication mode and/or a JavaScript communication mode;
step 42, communicating, according to the communication mode, with the host program through a first communication component, where the first communication component is arranged in the Flutter Web application and realizes information interaction based on a preset information format.

The Flutter Web application in the solution provided by the embodiment of the present disclosure can select the communication mode, that is, can select the first communication component, or the first communication component and the second communication component to communicate with the host program. In the present embodiment, by setting the first communication component, the Flutter Web application is enabled to establish the WebSocket communication with the host program: by setting the first communication component and the second communication component, the Flutter Web application is enabled to perform JavaScript communication with the host program, so as to make the Flutter Web application adapt to different platforms, thus to achieve effect of insensitivity to different platforms.

In an embodiment, the preset information format includes at least one of the following: parameter initialization (init), message sending (sendMessage), asynchronous message sending (sendMessageAsync) and message monitoring (onReceiveMessage).

In an embodiment, the communicating, according to the communication mode, with the host program through the first communication component includes:
when the communication mode is WebSocket communication mode, selecting, by the Flutter Web application, the first communication component, and communicating, by the Flutter Web application, with the host program through the first communication component.

In an embodiment, the communicating, by the Flutter Web application, with the host program through the first communication component includes:
sending, by the Flutter Web application, a first message to the first communication component, to cause the first communication component to convert the first message to a second message and send the second message to the host program: generating, by the host program according to the second message, a first response message and sending the first response message to the first communication component: where the first message and the second response message adopt a Flutter data format, and the second message and the first response message adopt a JavaScript data format;
acquiring, by the Flutter Web application, a second response message returned by the first communication component.

In an embodiment, the communicating, by the Flutter Web application, with the host program through the first communication component includes:
acquiring, by the Flutter Web application, a fourth message sent by the first communication component, where the fourth message is obtained by converting, by the first communication component, a third message from the host program;
in response to the fourth message, generating, by the Flutter Web application, a third response message and sending the third response message to the first communication component, to cause the first communication component to convert the third response message to a fourth response message and send the fourth response message to the host program;
where the fourth message and the third response message adopt a Flutter data format, and the third message and the fourth response message adopt a JavaScript data format.

In an embodiment, the first communication component includes an interface provided by a Flutter end in the Flutter Web application to be called by a JavaScript end in the host program, so as to convert a Flutter data format of the Flutter end and a JavaScript data format of the JavaScript end.

In an embodiment, the communicating, according to the communication mode, with the host program through the first communication component includes:
when the communication mode is the JavaScript communication mode, selecting, by the Flutter Web application, the first communication component and a second communication component, and communicating, by the Flutter Web application, with the host program through the first communication component and the second communication component;
where the first communication component is arranged in the Flutter Web application and realizes information interaction based on a preset information format; the second communication component is arranged in the host program and realizes information interaction based on the preset information format.

In an embodiment, the communicating, by the Flutter Web application, with the host program through the first communication component and the second communication component includes:
sending, by the Flutter Web application, a first message to the first communication component, to cause the first communication component to convert the first message to a second message and send the second message to the second communication component, and to cause the second communication component to convert the second message to a third message and send the third message to the host program: generating, according to the third message by the host program, a first response message and sending the first response message to the second communication component, to cause the second communication component to convert the first response message to a second response message and send the second response message to the first communication component, and to cause the first communication component to convert the second response message to a third response message; where the first message and the third response message adopt a Flutter data format, the second message and the second response message adopt a JavaScript data format, and the third message and the first response message adopt a data format of the host program;
acquiring, by the Flutter Web application, a third response message returned by the first communication component.

In an embodiment, the communicating, by the Flutter Web application, with the host program through the first communication component and the second communication component includes:
acquiring, by the Flutter Web application, a fourth message sent by the first communication component, where the fourth message is obtained by converting, by the first communication component, a fifth message from the second communication component; and the fifth message is obtained by converting, by the second communication component, a sixth message from the host program;
in response to the fourth message, generating, by the Flutter Web application, a fourth response message and sending the fourth response message to the first communication component, to cause the first communication component to convert the fourth response message to a fifth response message and send the fifth response message to the second communication component; and to cause the second communication component to convert the fifth response message to a sixth response message and send the sixth response message to the host program;
where the fourth message and the fourth response message adopt a Flutter data format, the fifth message and the fifth response message adopt a JavaScript data format, the sixth message and the sixth response message adopt a data format of the host program.

In an embodiment, the second communication component includes an interface obtained by encapsulating a Dart script library, so as to convert a JavaScript data format of a JavaScript end and a data format corresponding to the host program.

Based on the architecture of FIG. 1, an embodiment of the present disclosure provides a communication method, applied to a Flutter Web application, where the method includes:
acquiring a communication mode between the Flutter Web application and a host program, where the communication mode includes a WebSocket communication mode and/or a JavaScript communication mode;
communicating, according to the communication mode, with the host program through a first communication component, where the first communication component is arranged in the Flutter Web application and realizes information interaction based on a preset information format.

In an embodiment, the preset information format includes at least one of the following: parameter initialization (init), message sending (sendMessage), asynchronous message sending (sendMessageAsync) and message monitoring (onReceiveMessage).

In an embodiment, when the communication mode is the WebSocket communication mode, the communicating, by the Flutter Web application, with the host program through the first communication component includes:
sending a first message to the first communication component, to cause the first communication component to convert the first message to a second message and send the second message to the host program;
acquiring a first response message returned by the host program, converting the first response message to a second response message, and acquiring the second response message.

In an embodiment, when the communication mode is the WebSocket communication mode, the communicating, by the Flutter Web application, with the host program through the first communication component includes:
acquiring a fourth message sent by the first communication component, where the fourth message is obtained by converting, by the first communication component, a third message from the host program;
in response to the fourth message, generating a third response message and sending the third response message to the first communication component, to cause the first communication component to convert the third response message to a fourth response message and send the fourth response message to the host program;
where the fourth message and the third response message adopt a Flutter data format, and the third message and the fourth response message adopt a JavaScript data format.

In an embodiment, when the communication mode is the JavaScript communication mode, the communicating, according to the communication mode, with the host program through the first communication component includes:
sending a first message to the first communication component, to cause the first communication component to convert the first message to a second message and send the second message to a second communication component;
acquiring a second response message sent by the second communication component and converting the second response message to a third response message;
acquiring a third response message returned by the first communication component;
where the first message and the third response message adopt a Flutter data format, and the second message and the second response message adopt a JavaScript data format.

In an embodiment, when the communication mode is the JavaScript communication mode, the communicating, according to the communication mode, with the host program through the first communication component includes:
acquiring a fourth message sent by the first communication component, where the fourth message is obtained by converting, by the first communication component, a fifth message from a second communication component;
in response to the fourth message, generating a fourth response message and sending the fourth response message to the first communication component, to cause the first communication component to convert the fourth response message to a fifth response message and send the fifth response message to the second communication component;
where the fourth message and the fourth response message adopt a Flutter data format, and the fifth message and the fifth response message adopt a JavaScript data format.

It should be noted that the method shown in the present embodiment matches with content of the above-mentioned embodiment shown in FIG. 1, the content of the above-mentioned program embodiment can be referred to, which will not be repeated here.

The above embodiments can be fully or partially implemented by software, hardware, firmware or any combination thereof. When implemented using a software program, it can be fully or partially implemented in a form of a computer program product. The computer program product includes one or more computer instructions. When the one or more computer instructions are loaded or executed on a computer, processes or functions in the embodiments of the present disclosure are fully or partially generated. The computer may be a general-purpose computer, a special-purpose computer, a computer network or other programmable apparatuses. The computer instructions may be stored in a computer-readable storage medium. The computer-readable storage medium may be any available medium that a computer can access, or a data storage device such as a server or a data center that includes one or more integrated available media. The available medium may be a magnetic medium (e.g., a floppy disk, a magnetic disk, a magnetic tape), an optical medium (e.g., a digital video disc. (DVD)), or a semiconductor medium (e.g., a solid-state drive (SSD)) and the like.

Some embodiments of the present disclosure provide a computer-readable storage medium (e.g., a non-transitory computer-readable storage medium), where the computer-readable storage medium stores a computer program instruction, and when the computer program instruction is running on a processor, a computer is caused to perform a data processing method as described in any of the above embodiments, such as one or more steps of the data processing method.

Illustratively, the above computer-readable storage medium may include, but is not limited to, a magnetic storage device (e.g., a hard disk, a floppy disk or a tape), an optical disk (e.g., a compact disk (CD), a DVD (Digital Versatile Disk), etc.), a smart card and a flash memory device (e.g., EPROM (Erasable Programmable Read-Only Memory), a card, a stick or a key driver, etc.). Various computer-readable storage medium described in the present disclosure may represent one or more devices and/or other machine-readable storage medium for storing information. The term “machine-readable storage medium” may include, but is not limited to, a wireless channel and various other media capable of storing, containing and/or carrying instructions and/or data.

The processor mentioned in the embodiment of the present disclosure can be a central processing unit (CPU), a general processor, a digital signal processor (DSP), an application-specific integrated circuit (ASIC), a field programmable gate array (FPGA) or other programmable logic devices, transistor logic devices, hardware components or any combination thereof. The processor may implement or perform various illustrative logical blocks and modules described in connection with the present disclosure. A processor can also be a combination of computing functions, such as one or more microprocessors, a combination of DSP and microprocessors, and so on.

In addition, the memory mentioned in the embodiment of the present disclosure may be random access memory (RAM), a flash memory, a read only memory (ROM), an erasable programmable read only memory (EPROM), an electrically erasable programmable read-only memory (EEPROM), a register, a hard disk, a removable hard disk, a CD-ROM, or any other form of storage medium known in the art.

Those skilled in the art can easily think of other embodiments of the present disclosure after considering the specification and practicing the disclosure disclosed herein. The present disclosure is intended to cover any variations, uses or adaptations that follow the general principles of the present disclosure and include common sense or common technical means in the technical field that are not disclosed in the present disclosure. The specification and embodiments are to be regarded as illustrative only, with the true scope and spirit of the present disclosure being indicated by the following claims.

It should be understood that the present disclosure is not limited to the precise structure described above and shown in the drawings, and various modifications and changes can be made without departing from its scope. The scope of the present disclosure is limited only by the appended claims.

1. A communication method for a Flutter Web application and a host program, wherein the host program comprises at least one of: an Android system, an iOS system, a Windows system or a Web program; and the host program is used to provide a runnable environment for the Flutter Web application; the method comprises:
acquiring a communication mode between the Flutter Web application and the host program, wherein the communication mode comprises at least one of a WebSocket communication mode or a JavaScript communication mode; and
communicating, according to the communication mode, with the host program through a first communication component, wherein the first communication component is arranged in the Flutter Web application and realizes information interaction based on a preset information format.

2. The method according to claim 1, wherein the preset information format comprises at least one of: parameter initialization (init), message sending (sendMessage), asynchronous message sending (sendMessageAsync) and message monitoring (onReceiveMessage).

3. The method according to claim 1, wherein communicating, according to the communication mode, with the host program through the first communication component comprises:
when the communication mode is WebSocket communication mode, selecting, by the Flutter Web application, the first communication component, and communicating, by the Flutter Web application, with the host program through the first communication component.

4. The method according to claim 3, wherein communicating, by the Flutter Web application, with the host program through the first communication component comprises:
sending, by the Flutter Web application, a first message to the first communication component, such that the first communication component converts the first message to a second message and sends the second message to the host program; and the host program generates, according to the second message, a first response message and sends the first response message to the first communication component; and
acquiring, by the Flutter Web application, a second response message returned by the first communication component; wherein the first message and the second response message adopt a Flutter data format, and the second message and the first response message adopt a JavaScript data format.

5. The method according to claim 3, wherein communicating, by the Flutter Web application, with the host program through the first communication component comprises:
acquiring, by the Flutter Web application, a fourth message sent by the first communication component, wherein the fourth message is obtained by converting, by the first communication component, a third message from the host program; and
in response to the fourth message, generating, by the Flutter Web application, a third response message and sending the third response message to the first communication component, to cause the first communication component to convert the third response message to a fourth response message and send the fourth response message to the host program;
wherein the fourth message and the third response message adopt a Flutter data format, and the third message and the fourth response message adopt a JavaScript data format.

6. The method according to claim 1, wherein the first communication component comprises an interface provided by a Flutter end in the Flutter Web application to be called by a JavaScript end in the host program, so as to convert a Flutter data format of the Flutter end and a JavaScript data format of the JavaScript end.

7. The method according to claim 1, wherein communicating, according to the communication mode, with the host program through the first communication component comprises:
when the communication mode is the JavaScript communication mode, selecting, by the Flutter Web application, the first communication component and a second communication component, and communicating, by the Flutter Web application, with the host program through the first communication component and the second communication component;
wherein the first communication component is arranged in the Flutter Web application and realizes information interaction based on a preset information format; the second communication component is arranged in the host program and realizes information interaction based on the preset information format.

8. The method according to claim 7, wherein communicating, by the Flutter Web application, with the host program through the first communication component and the second communication component comprises:
sending, by the Flutter Web application, a first message to the first communication component, such that the first communication component converts the first message to a second message and sends the second message to the second communication component; the second communication component converts the second message to a third message and sends the third message to the host program; the host program generates, according to the third message, a first response message and sends the first response message to the second communication component; the second communication component converts the first response message to a second response message and sends the second response message to the first communication component; and the first communication component converts the second response message to a third response message; wherein the first message and the third response message adopt a Flutter data format, the second message and the second response message adopt a JavaScript data format, and the third message and the first response message adopt a data format of the host program; and
acquiring, by the Flutter Web application, the third response message returned by the first communication component.

9. The method according to claim 7, wherein communicating, by the Flutter Web application, with the host program through the first communication component and the second communication component comprises:
acquiring, by the Flutter Web application, a fourth message sent by the first communication component, wherein the fourth message is obtained by converting, by the first communication component, a fifth message from the second communication component; and the fifth message is obtained by converting, by the second communication component, a sixth message from the host program; and
in response to the fourth message, generating, by the Flutter Web application, a fourth response message and sending the fourth response message to the first communication component, to cause the first communication component to convert the fourth response message to a fifth response message and send the fifth response message to the second communication component; and to cause the second communication component to convert the fifth response message to a sixth response message and send the sixth response message to the host program;
wherein the fourth message and the fourth response message adopt a Flutter data format, the fifth message and the fifth response message adopt a JavaScript data format, the sixth message and the sixth response message adopt a data format of the host program.

10. The method according to claim 7, wherein the second communication component comprises an interface obtained by encapsulating a Dart script library, so as to convert a JavaScript data format of a JavaScript end and a data format corresponding to the host program.

11. A communication method, applied to a Flutter Web application, comprising:
acquiring a communication mode between the Flutter Web application and a host program, wherein the communication mode comprises at least one of a WebSocket communication mode or a JavaScript communication mode; and
communicating, according to the communication mode, with the host program through a first communication component, wherein the first communication component is arranged in the Flutter Web application and realizes information interaction based on a preset information format.

12. The method according to claim 11, wherein the preset information format comprises at least one of: parameter initialization (init), message sending (sendMessage), asynchronous message sending (sendMessageAsync) and message monitoring (onReceiveMessage).

13. The method according to claim 11, wherein when the communication mode is the WebSocket communication mode, communicating, by the Flutter Web application, with the host program through the first communication component comprises:
sending a first message to the first communication component, to cause the first communication component to convert the first message to a second message and send the second message to the host program; and
acquiring a second response message sent by the first communication component, wherein the second response message is converted from a first response message by the first communication component, and the first response message is returned by the host program.

14. The method according to claim 11, wherein when the communication mode is the WebSocket communication mode, communicating, by the Flutter Web application, with the host program through the first communication component comprises:
acquiring a fourth message sent by the first communication component, wherein the fourth message is obtained by converting, by the first communication component, a third message from the host program; and
in response to the fourth message, generating a third response message and sending the third response message to the first communication component, to cause the first communication component to convert the third response message to a fourth response message and send the fourth response message to the host program;
wherein the fourth message and the third response message adopt a Flutter data format, and the third message and the fourth response message adopt a JavaScript data format.

15. The method according to claim 11, wherein when the communication mode is the JavaScript communication mode, communicating, according to the communication mode, with the host program through the first communication component comprises:
sending a first message to the first communication component, to cause the first communication component to convert the first message to a second message and send the second message to a second communication component;
acquiring a third response message returned by the first communication component, wherein the third response message is converted from a second response message by the second communication component;
wherein the first message and the third response message adopt a Flutter data format, and the second message and the second response message adopt a JavaScript data format.

16. The method according to claim 11, wherein when the communication mode is the JavaScript communication mode, communicating, according to the communication mode, with the host program through the first communication component comprises:
acquiring a fourth message sent by the first communication component, wherein the fourth message is obtained by converting, by the first communication component, a fifth message from a second communication component;
in response to the fourth message, generating a fourth response message and sending the fourth response message to the first communication component, to cause the first communication component to convert the fourth response message to a fifth response message and send the fifth response message to the second communication component;
wherein the fourth message and the fourth response message adopt a Flutter data format, and the fifth message and the fifth response message adopt a JavaScript data format.

17. A computer device, comprising:
a processor;
a memory for storing a computer program executable by the processor;
wherein the processor is configured to execute the computer program in the memory to implement the method according to claim 1.

18. A non-transitory computer-readable storage medium, wherein when an executable computer program in the storage medium is executed by a processor, the method according to claim 1.
